(19) United States
(12) Patent Application Publication
(10) Pub. No.: US 2007/0268062 A1
(43) Pub. Date: Nov. 22, 2007

(54) Fuse circuit for repair and detection

(75) Inventors: Der-Min Yuan, Hsin Chuang City (TW); Ming Hung Wang, Hsinchu City (TW)

Correspondence Address: BIRCH STEWART KOLASCH & BIRCH, PO BOX 747, FALLS CHURCH, VA, 22040-0747, US

(73) Assignee: Etron Technology, Inc.

(21) Appl. No.: 11/434,812

(22) Filed: May 17, 2006

(51) Int. Cl. H01H 37/76

(52) U.S. Cl. 327/525

(57) ABSTRACT

A fuse circuit for repair and detection includes a fuse resistor, a reference resistor, a voltage sensing circuit, an OP amplifier and a latch circuit. The resistance difference is correctly sensed by means of the voltage sensing circuit and the OP amplifier according to a voltage difference. Hence, whether the fuse resistor is programmed or not is accurately detected by the logic level of the output signal.

### BACKGROUND OF THE INVENTION

1. Field of the Invention

The invention relates to a semiconductor device, and more particularly to a fuse circuit for repair and detection.

2. Description of the Related Art

Conventionally, fuse circuits are widely used in memory devices, particularly in a memory redundancy control achieved by programmed fuses.

FIG. 1 shows a circuit diagram illustrating a conventional fuse circuit 100. The fuse circuit 100 includes two PMOS transistors 111 and 121, a fuse 110, a reference resistor 120, three NMOS transistors 112, 113, and 122 and an inverter 130. The fuse 110, which is an electrical fuse, is programmed to adjust its resistance value.

However, in the conventional design, the output of the inverter 130 fails to indicate the conductive state of the fuse 110 after the fuse 110 has been programmed. In other words, the fuse circuit 100 fails to distinguish whether the fuse 110 is programmed or not. This is because the voltages at two nodes A and B are determined not by the resistance difference between the fuse 110 and the reference resistor 120, but by parasitic capacitances of the nodes A and B.

Thus, even though the resistance value of the fuse 110 is varied after having been programmed, the output signal FUSE OUT generated by the fuse circuit 100 is still at a logic high level that erroneously indicates the fuse 110 is not programmed. This may seriously decrease the reliability of a memory device incorporating the fuse 110.

### SUMMARY OF THE INVENTION

In view of the above-mentioned problems, an object of the invention is to provide a fuse circuit that allows for accurately indicating whether an electric fuse is programmed or not.

To achieve the above-mentioned object, the fuse circuit includes a fuse resistor, a reference resistor, a voltage sensing circuit, and an OP (operational) amplifier. The fuse resistor and the reference resistor are connected to the first power terminal. The voltage sensing circuit is enabled by a first control pulse signal for generating a first node voltage and a second node voltage according to the resistance values of the fuse resistor and the reference resistor. The OP amplifier then receives the first node voltage and the second node voltage, amplifies the voltage difference between the first node voltage and the second node voltage to a voltage level of the first power terminal or the second power terminal, and generates an amplified voltage.

According to one aspect of the invention, the voltage sensing circuit may include a first, a second, a third, and a fourth transistor. The source of the first transistor is connected to the fuse resistor, the gate of the first transistor receives the first control pulse signal, and the drain of the first transistor generates the first node voltage. The source of the second transistor is connected to the reference resistor, the gate of the second transistor is connected to the gate of the first transistor, and the drain of the second transistor generates the second node voltage. The drain of the third transistor is connected to the drain of the first transistor, and the source of the third transistor is connected to the second power terminal. The drain of the fourth transistor is connected to the drain of the second transistor, the source of the fourth transistor is connected to the second power terminal, and the gate of the fourth transistor is connected to both the gate of the third transistor and the drain of the fourth transistor.

### BRIEF DESCRIPTION OF THE DRAWINGS

FIG. 1 shows a circuit diagram illustrating a conventional fuse circuit.

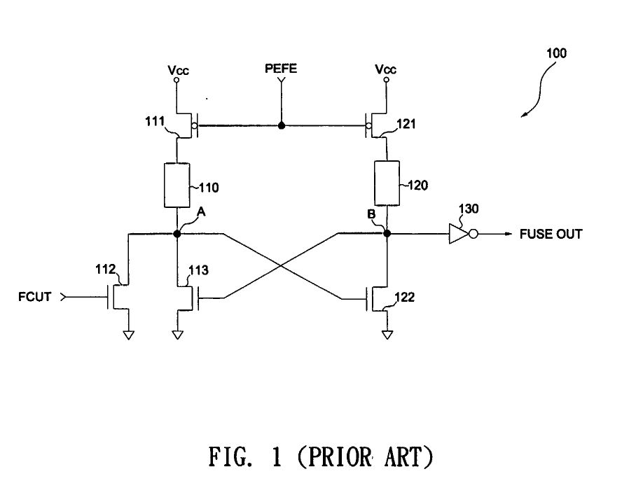

FIG. 2 shows a circuit diagram illustrating a fuse circuit according to the invention.

FIG. 3 shows a diagram illustrating three signals DETECTB, DET_PLSB, and Vav and a voltage difference (V_{IN}−V_{INB}).

### DETAILED DESCRIPTION OF THE INVENTION

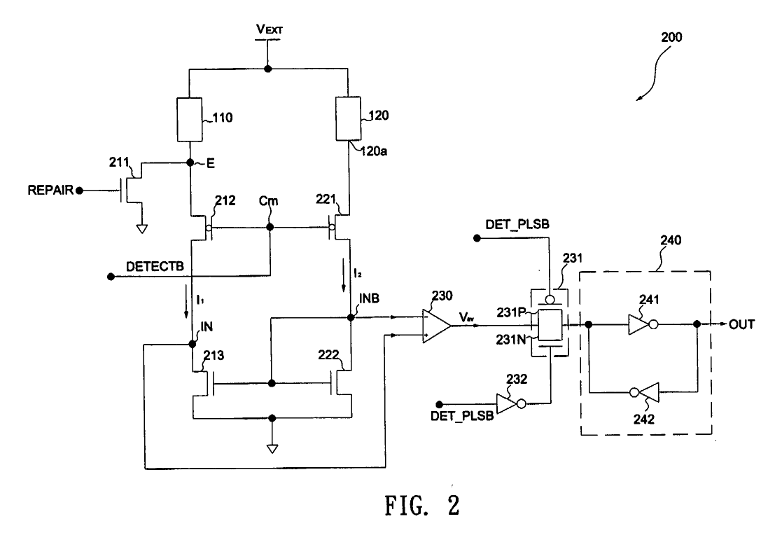

FIG. 2 shows a circuit diagram illustrating a fuse circuit according to the invention. Referring to FIG. 2, the fuse circuit 200 includes a fuse 110, a reference resistor 120, three NMOS transistors 211, 213 and 222, two PMOS transistors 212 and 221, an OP amplifier 230, a transmission gate 231 and a latch circuit 240.

The fuse 110 may be an electric fuse, and the transmission gate 231 includes a PMOS transistor 231P and a NMOS transistor 231N. The fuse 110 and the reference resistor 120 have different resistance values. For example, before the fuse 110 is programmed, the resistance value of the fuse 110 is smaller than that of the reference resistor 120, while the resistance value of the fuse 110 is larger than that of the reference resistor 120 after the fuse 110 has been programmed. The fuse 110 is connected between a power supply voltage V_{EXT} and a node E, and the node E is connected to the source of the PMOS transistor 212. The gate of the PMOS transistor 212 is connected to the gate of the PMOS transistor 221, and its drain is connected to a node IN. Meanwhile, the common gate terminal Cm of the PMOS transistors 212 and 221 receives an active-low control pulse signal DETECTB. The node IN is also connected to the drain of the NMOS transistor 213 and a positive input terminal of the OP amplifier 230. The gate of the NMOS transistor 213 is connected to a node INB, and its source is connected to the ground voltage GND. The drain of the NMOS transistor 211 used for programming the fuse 110 is connected to the node E, and its source is connected to the ground voltage GND. Further, the gate of the NMOS transistor 211 receives an active-high program pulse signal REPAIR.

Also, the reference resistor 120 is connected to the power supply voltage V_{EXT}. The source of the PMOS transistor 221 is connected to a terminal 120a of the reference resistor 120, and its drain is connected to the node INB. The source of the NMOS transistor 222 is connected to the ground voltage GND, while its drain and gate are short-circuited to the node INB. The voltages of the nodes IN and INB are respectively sent to the positive input terminal and the negative input terminal of the OP amplifier 230. The output terminal of the OP amplifier 230 is connected to the input terminal of the transmission gate 231 controlled by an active-low control pulse signal DET_PLSB. The input terminal of the latch circuit 240 that consists of two inverters 241 and 242 is connected to the output terminal of the transmission gate 231, and an output signal OUT is output via its output terminal.

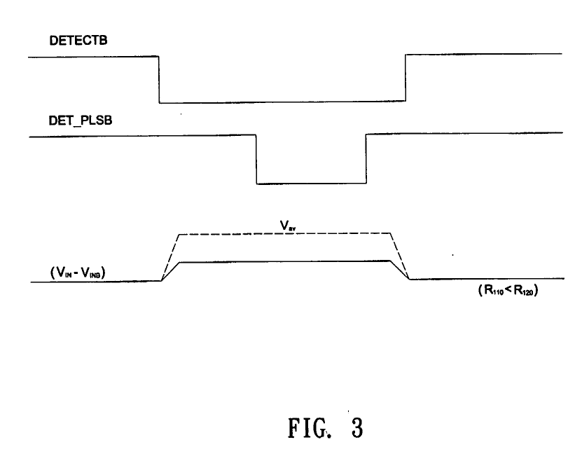

FIG. 3 shows a diagram illustrating three signals DETECTB, DET_PLSB, and Vₐᵥ and a voltage difference (V_{IN}−V_{INB}). The operations of the fuse circuit 200 are described as the following with reference to FIG. 3.

First, assume that the resistance value R₁₁₀ of the fuse 110 is smaller than the resistance value R₁₂₀ of the reference resistor 120 before programming, and that the control pulse signal DET_PLSB is in a logic high level state. After the control pulse signal DETECTB is changed from a logic high level to a logic low level, the PMOS transistors 212 and 221 are turned on or enabled. Since the NMOS transistors 213 and 222 form a current mirror, currents I₁ and I₂ that respectively pass through the fuse 110 and the reference resistor 120 are constant. In case that both NMOS transistors 213 and 222 are identical, currents I₁ and I₂ should be equal. Accordingly, on condition that the resistance value R₁₁₀ of the fuse 110 is smaller than the resistance value R₁₂₀ of the reference resistor 120, the voltage V_{IN} of the node IN is set higher than the voltage V_{INB} of the node INB, and therefore the voltage difference (V_{IN}−V_{INB}) is positive. The OP amplifier 230 amplifies the voltage difference (V_{IN}−V_{INB}) to the level of the power supply voltage V_{EXT} and then generates an amplified voltage Vav (shown in FIG. 3).

After a predetermined time has elapsed and the control pulse signal DET_PLSB has been changed from a logic high level to a logic low level, the PMOS transistor 231P and the NMOS transistor 231N of the transmission gate 231 are switched on. The amplified voltage Vav at a logic high level is then transmitted through the transmission gate 231 and sent to the latch circuit 240. Finally, the amplified voltage Vav is latched by the latch circuit 240. Consequently, the fuse circuit 200 outputs an output signal OUT at a logic low level indicating that the fuse 110 is not programmed.

On the other hand, the resistance value R₁₁₀ of the fuse 110 is larger than the resistance value R₁₂₀ of the reference resistor 120 under the condition that the fuse 110 is programmed. The PMOS transistors 212 and 221 are turned on or enabled after the control pulse signal DETECTB is changed from a logic high level to a logic low level. Since the resistance value R₁₁₀ of the fuse 110 is larger than the resistance value R₁₂₀ of the reference resistor 120, the voltage V_{IN} of the node IN is set lower than the voltage V_{INB} of the node INB and therefore the voltage difference (V_{IN}−V_{INB}) is negative. Clearly, the current I₁ is still constant, but the drain-to-source voltage V_{IN} of the NMOS transistor 213 is varied after the fuse 100 is programmed. This is because the NMOS transistor 213 operates in the saturation region. Next, the OP amplifier 230 amplifies the voltage difference (V_{IN}−V_{INB}) to the level of the ground voltage GND and generates an amplified voltage Vav (not shown).

After a predetermined time has elapsed and the control pulse signal DET_PLSB is changed from a logic high level to a logic low level, the NMOS transistor 231N and the PMOS transistor 231P of the transmission gate 231 are switched on. The amplified voltage Vav at a low level is then transmitted through the transmission gate 231 and sent to the latch circuit 240. Finally, the amplified voltage Vav from the OP amplifier 230 is latched by the latch circuit 240. As a result, the fuse circuit 200 outputs an output signal OUT at a logic high level indicating that the fuse 110 is programmed.

According to the invention, the resistance difference of the fuse 110 is correctly sensed by means of the current mirror (formed by NMOS transistors 213 and 222), and the OP amplifier 230 further operates based on a subsequent voltage difference measured in the fuse 110. Hence, whether the fuse is programmed or not can be accurately detected without any possible errors. Besides, due to the current mirror of the invention, the voltage levels of the node IN and node INB are not influenced by the parasitic capacitance. Thus, through the design of the invention, the reliability of a memory device incorporating programmable fuses is considerably improved.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A fuse circuit comprising:
a fuse resistor connected to a first power terminal;
a reference resistor connected to the first power terminal;
a voltage sensing circuit connected to the fuse resistor, the reference resistor and a second power terminal, the voltage sensing circuit being enabled by a first control pulse signal for generating a first node voltage and a second node voltage according to the resistance values of the fuse resistor and the reference resistor; and
an OP amplifier for receiving the first node voltage and the second node voltage and generating an amplified voltage, wherein the voltage difference between the first node voltage and the second node voltage is amplified to the level of the first power terminal or the second power terminal.

2. The fuse circuit of claim 1, further comprising a latch circuit for storing the amplified voltage generated by the OP amplifier.

3. The fuse circuit of claim 2, further comprising a transmission gate connected between the OP amplifier and the latch circuit for transmitting the amplified voltage according to a second control pulse signal.

4. The fuse circuit of claim 1, wherein the fuse resistor and the reference resistor have different resistance values.

5. The fuse circuit of claim 1, wherein the first power terminal is provided with a power supply voltage and the second terminal is provided with a ground voltage.

6. The fuse circuit of claim 5, wherein the voltage sensing circuit comprises:
a first transistor, the source of the first transistor being connected to the fuse resistor, the gate of the first transistor receiving the first control pulse signal, and the drain of the first transistor generating the first node voltage;
a second transistor, the source of the second transistor being connected to the reference resistor, the gate of the second transistor being connected to the gate of the first transistor, and the drain of the second transistor generating the second node voltage;
a third transistor, the drain of the third transistor being connected to the drain of the first transistor, and the source of the third transistor being connected to the second power terminal; and
a fourth transistor, the drain of the fourth transistor being connected to the drain of the second transistor, the source of the fourth transistor being connected to the second power terminal, and the gate of the fourth transistor being connected to both the gate of the third transistor and the drain of the fourth transistor.

7. The fuse circuit of claim 1, further comprising a program transistor connected between a third node and the second power terminal and turned on/off by a program pulse signal, wherein the third node is connected to the fuse resistor and the voltage sensing circuit.

8. The fuse circuit of claim 1, wherein the fuse resistor is an electric fuse.

9. A fuse circuit comprising:
a fuse resistor connected to a power supply voltage;
a reference resistor connected to the power supply voltage;
a first PMOS transistor, the source of the first PMOS transistor being connected to the fuse resistor element, the gate of the first PMOS transistor receiving a first control pulse signal, and the drain of the first PMOS transistor generating a first node voltage;
a second PMOS transistor, the source of the second PMOS transistor being connected to the reference resistor, the gate of the second PMOS transistor being connected to the gate of the first PMOS transistor, and the drain of the second PMOS transistor generating a second node voltage;
a first NMOS transistor, the drain of the first NMOS transistor being connected to the drain of the first PMOS transistor, the source of the first NMOS transistor being connected to a ground voltage;
a second NMOS transistor, the drain of the second NMOS transistor being connected to the drain of the second PMOS transistor, the source of the second NMOS transistor being connected to the ground voltage, and the gate of the second NMOS transistor being connected to the gate of the first NMOS transistor and the drain of the second NMOS transistor; and
an OP amplifier for receiving the first node voltage and the second node voltage and generating an amplified voltage, wherein the voltage difference between the first node voltage and the second node voltage is amplified to the level of the power supply voltage or the ground voltage.

10. The fuse circuit of claim 9, further comprising a latch circuit for storing the amplified voltage of the OP amplifier.

11. The fuse circuit of claim 10, further comprising a transmission gate connected between the OP amplifier and the latch circuit for transmitting the amplified voltage according to a second control pulse signal.

12. The fuse circuit of claim 9, further comprising a program transistor connected between a third node and the ground voltage and turned on/off by a program pulse signal, wherein the third node is connected to the fuse resistor and the source of the first PMOS transistor.

13. The fuse circuit of claim 9, wherein the fuse resistor and the reference resistor have different resistance values.

14. The fuse circuit of claim 9, wherein the fuse resistor is an electric fuse.
